(19) United States
(12) Patent Application Publication
(10) Pub. No.: US 2015/0164624 A1
(43) Pub. Date: Jun. 18, 2015

(54) ASPIRATOR TIP

(71) Applicant: Jonathan Sebastian White, Steubenville, OH (US)

(72) Inventor: Jonathan Sebastian White, Steubenville, OH (US)

(21) Appl. No.: 14/104,995

(22) Filed: Dec. 12, 2013

(51) Int. Cl. A61C 17/06

(52) U.S. Cl. CPC A61C 17/043

(57) ABSTRACT

An aspirator tip may include a tube having an internal spacing, a proximal first end and a distal second end. A tip may be included having a proximal end and a distal end. The tip may comprise a plurality of raised ridges that have a proximal end and a distal end. The space between the plurality of raised ridges may define a plurality of openings. The proximal end of the tip may attach to the distal second end of the tube.

### BACKGROUND OF THE INVENTION

The present invention relates to aspirator tips and, more particularly, to a saliva ejector tip.

Aspirator tips that are currently in use have openings that can be obstructed by tissue being drawn into them by suction, rendering the devices inoperative and causing potential damage to the tissue. Current devices have a simple open tube or have a cage like top section over the tube opening and solid base bottom section. The tissue blocking the openings prevents the removal of fluid. There is a need to constantly reposition the aspirator tip throughout a procedure due to the blocking of the openings.

As can be seen, there is a need for an aspirator tip that allows for the continuous and efficient fluid removal without repositioning by having a plurality of openings that may run the length of the aspirator tip and providing a plurality of raised ridges that are a distance from the openings that may prevent blockage of the openings.

### SUMMARY OF THE INVENTION

In one aspect of the present invention, an aspirator tip comprises: a tip having a proximal end and a distal end, wherein the tip comprises a plurality of raised ridges, wherein the plurality of raised ridges have a proximal end and a distal end, wherein the space between the plurality of raised ridges define a plurality of openings.

In another aspect of the present invention, an aspirator tip comprises: a tube having an internal housing, a proximal first end and a distal second end; a tip having a proximal end and a distal end, wherein the tip comprises a plurality of raised ridges, wherein the plurality of raised ridges have a proximal end and a distal end, wherein the space between the plurality of raised ridges define a plurality of openings, wherein the proximal end of the tip is attached to the distal second end of the tube.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention taken along line 2-2 in FIG. 1;

FIG. 3 is a section view of an exemplary embodiment of the present invention, illustrating the flow of fluids when an aspirator tip is against tissue;

FIG. 4 is a perspective view of an alternate exemplary embodiment of the present invention;

FIG. 5 is a section view of an exemplary embodiment of the present invention taken along line 5-5 in FIG. 4;

FIG. 6 is a perspective view of an alternate exemplary embodiment of the present invention; and

FIG. 7 is a section view of an exemplary embodiment of the present invention taken along line 7-7 in FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an aspirator tip that may include a tube having an internal housing, a proximal first end and a distal second end. A tip may be included having a proximal end and a distal end. The tip may comprise a plurality of raised ridges that have a proximal end and a distal end. The space between the plurality of raised ridges may define a plurality of openings. The proximal end of the tip may attach to the distal second end of the tube.

The present invention may include a tube and a tip attached to the tube, that allows users to provide a way to remove a fluid from an area without tissue or the like blocking the suction area. The present invention may include just the tip. The tip may provide a method of use that allows for the continuous placement of the aspirator tip for fluid removal. The spacing between the plurality of raised ridges and the height of the plurality of ridges prevents tissue from entering the suction area within the tip. The plurality of openings that may be found along the full length of the tip may provide areas where the aspirator tip may suction fluid. The distance from the suction area and the ends of the plurality of raised ridges may allow for enough space that the pull of the suction may not be enough to bring the tissue inside towards the plurality of openings, while still providing enough suction to remove the fluid from the area.

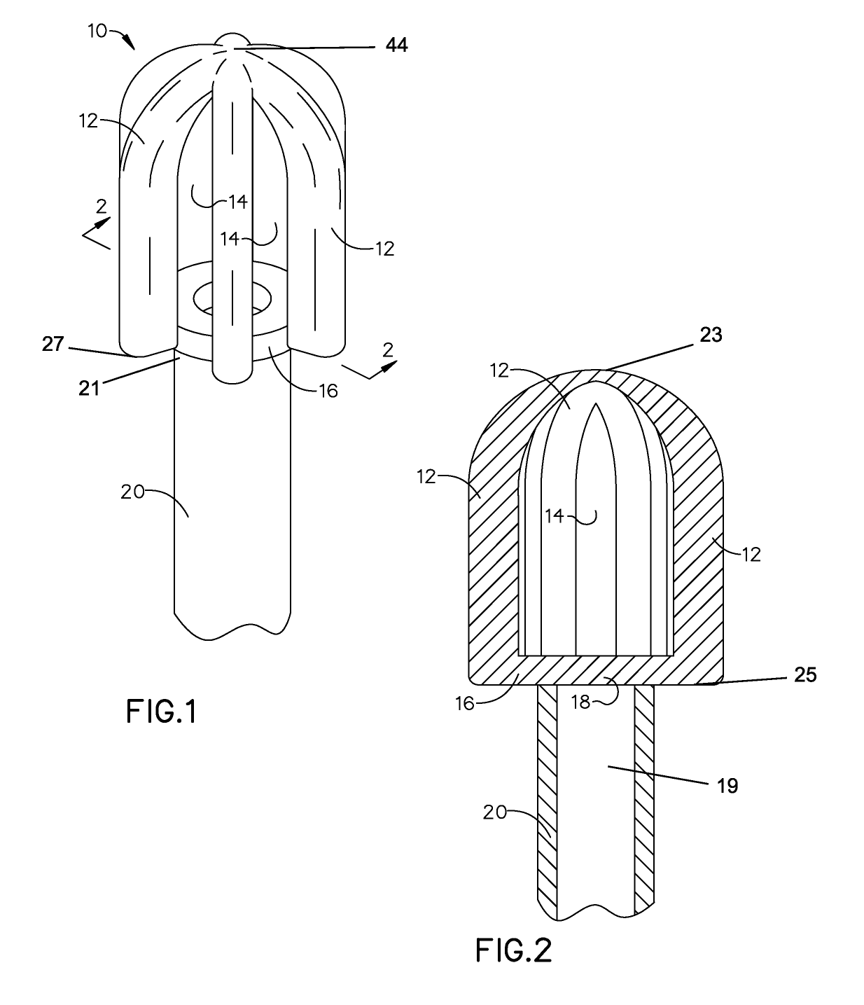

As is illustrated in FIGS. 1 through 7, the present invention may include a tube 20 and a tip 10. The tube 20 may have an internal housing 19, a proximal first end and a distal second end 21. The tip 10 may have a proximal end 25 and a distal end 23. The tip 10 may include a plurality of raised ridges 12. The space between the plurality of raised ridges 12 may define a plurality of openings 14. In certain embodiments, the tip 10 may include a central connection piece 16. The central connection piece 16 may attach to the distal second end 21 of the tube 20. The central connection piece 16 may have an opening 18 to the tube 20.

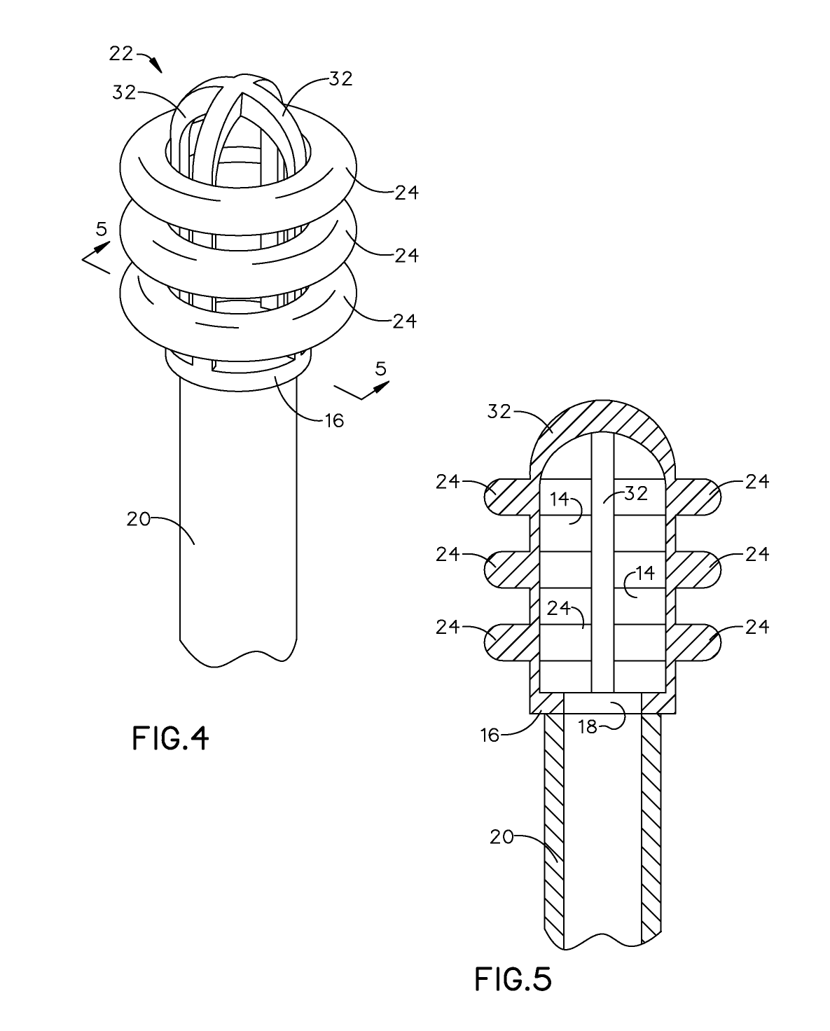

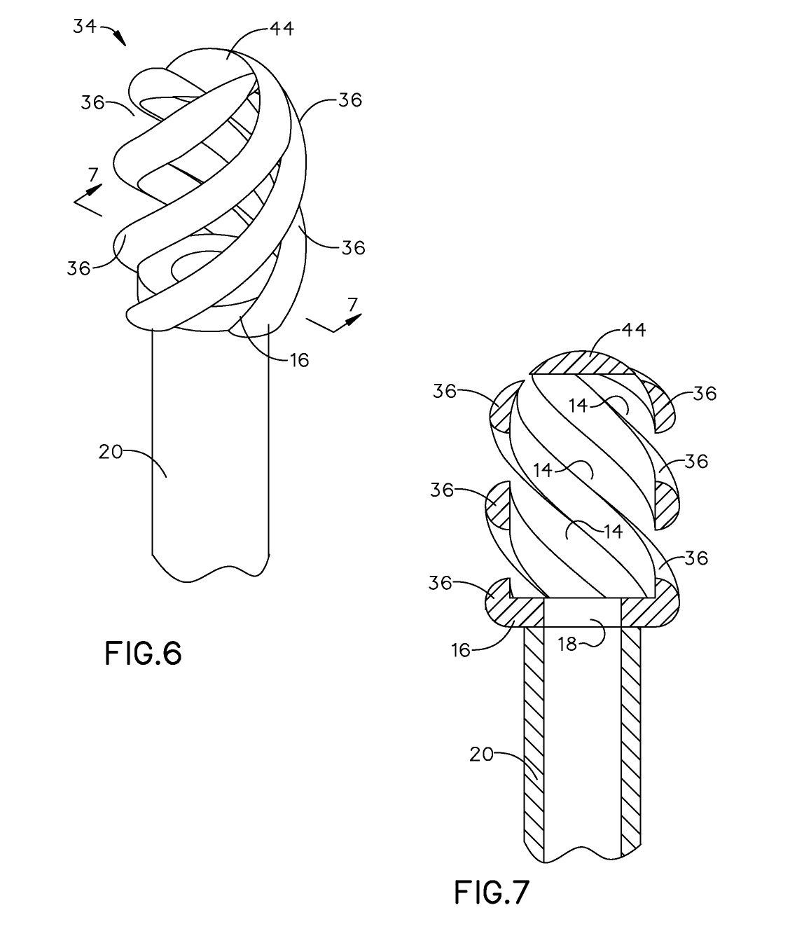

In certain embodiments, the plurality of raised ridges 12 may be in a vertical configuration or the like. In certain embodiments, the plurality of raised ridges 12 may be in a horizontal configuration 24 as is show in the first alternate embodiment 22 in FIGS. 4 and 5. In certain embodiments, the plurality of raised ridges 12 may be in a spiral configuration 36 as is shown in the second alternate embodiment 34 in FIGS. 6 and 7. In certain embodiments, the central connection piece 16 may be in the shape of a plurality of center support arches 32.

In certain embodiments, the present invention may have a distal end 23 of the tip 10 that may be a rounded, ovoid, or the like. In certain embodiments, the tube 20 may include a wire or the like run through the internal housing 19. The tube 20 may also be made entirely from metal, other rigid materials or the like.

In certain embodiments the present invention may include a plurality of raised ridges 12 that are spaced so that tissue may not enter into the plurality of openings 14 created between the plurality of raised ridges 12. Since the plurality of openings 14 cover the full length of the tip 10, the coverage for suction, the area of the plurality of openings 14, may be enough so that fluid may be suctioned through the tip 10 and into the tube 20. The plurality of raised ridges may have a proximal end 27 and a distal end 44. In certain embodiments, the proximal end 27 of the plurality of raised ridges 12 may be at a point approximately parallel with the distal second end 21 of the tube 20, which in turn may provide the plurality of openings 14 to be positioned approximately at the level of the distal second end 21 of the tube 20.

A method of constructing the present invention may include the following; make the tip 10 and tube 20 by injection molding. The tip 10 and tube 20 may be attached by an adhesive. In certain embodiments, the tip 10 and tube 20 may be attached by fusing the components together by direct heat. In certain embodiments, the tip 10 and tube 20 may be attached by fusing the components together by soldering, brazing, welding or the like. The tip 10 may be constructed of any appropriate material such as metal, rigid plastic or a flexible soft material such as vinyl or the like. The aspirator tip may have a tip 10 that is rounded, ovoid, or the like. The tip 10 may have a width and length of any practical size determined by the area of its intended use. For example, in a dental saliva ejector use the width and length may be approximately 3 to 40 mm in width and approximately 5 to 40 mm in length. The tip 10 may include a plurality of raised ridges 12 that may have a height of approximately 1 mm to 5 mm. In certain embodiments, the ratio of the height of the plurality of raised ridges to the width of the plurality of openings may be in the range of approximately 1.5-4.0:1.

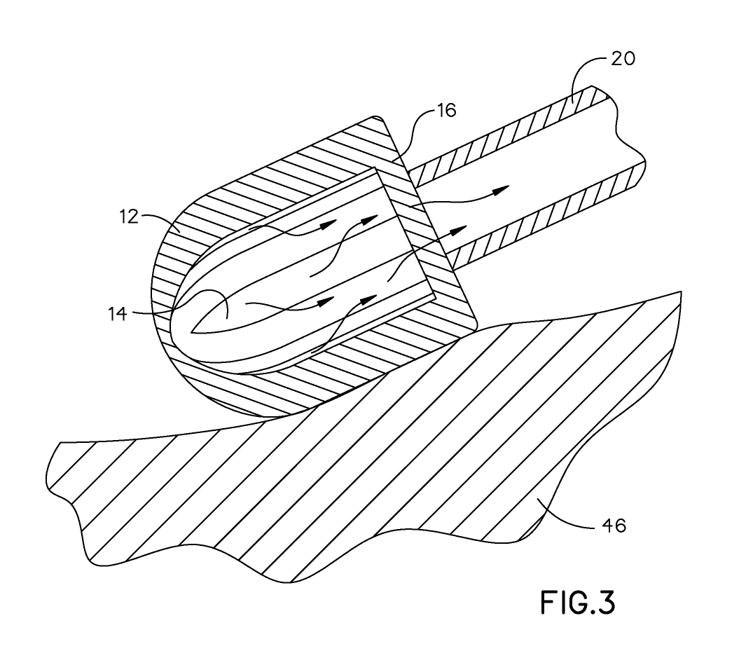

A method of using the present invention may include the following. Place the tube 20 and tip 10 inside the mouth area of an individual. The tube 20 may be bent into a position, and may stay in the position due to the wire or similar device within the internal housing 19 of the tube 20. The user may provide some suctioning method through the tube 20. The tip 10 of the aspirator tip may be alongside tissue within the mouth of the individual. While a procedure is being conducted, the aspirator tip may stay in the position it was placed, while suctioning fluids gathering in the area the aspirator tip was placed. The plurality of raised ridges 12 may sit along the tissue as is shown in FIG. 3. While in position, the spacing and distance of the raised ridges may allow for the possibility of the tissue to stay out of the suction and stay out of the opening. The plurality of openings 14 may proceed to be used as a pathway for the fluid unobstructed by tissue. In certain embodiments, the present invention may be used in procedures other than dental procedures where suction may be required.

It should be understood, of course, that the foregoing relates to exemplary embodiments of the invention and that modifications may be made without departing from the spirit and scope of the invention as set forth in the following claims.

What is claimed is:

1. An aspirator tip comprising:
a tip having a proximal end and a distal end, wherein the tip comprises a plurality of raised ridges, wherein the plurality of raised ridges have a proximal end and a distal end, wherein the space between the plurality of raised ridges define a plurality of openings.

2. The aspirator tip of claim 1, further comprising a tube having an internal housing, a proximal first end and a distal second end, wherein the proximal end of the tip is attached to the distal second end of the tube.

3. The aspirator tip of claim 2, wherein the tip further comprises a central connection piece, wherein the central connection piece attaches to the plurality of raised ridges and the distal second end of the tube.

4. The aspirator tip of claim 1, wherein the plurality of raised ridges extend the full length of the tip.

5. The aspirator tip of claim 1, wherein the plurality of raised ridges are in a vertical configuration.

6. The aspirator tip of claim 1, wherein the plurality of raised ridges are in a horizontal configuration.

7. The aspirator tip of claim 1, wherein the plurality of raised ridges are in a spiral configuration.

8. The aspirator tip of claim 1, wherein the tip is approximately 3 to 40 mm in width and approximately 5 to 40 mm in length.

9. The aspirator tip of claim 1, wherein the plurality of raised ridges are approximately 1 mm to 5 mm in height.

10. The aspirator tip of claim 1, wherein the ratio of the height of the plurality of raised ridges to the width of the plurality of openings is in the range of approximately 1.5-4.0:1.

11. The aspirator tip of claim 2, wherein the tube is a flexible hollow tube having a wire within the internal housing, wherein the wire allows the tube to retain a position after being bent into the position.

12. The aspirator tip of claim 1, wherein the distal end of the tip has a rounded end.

13. An aspirator tip comprising:
a tube having an internal housing, a proximal first end and a distal second end;
a tip having a proximal end and a distal end, wherein the tip comprises a plurality of raised ridges, wherein the plurality of raised ridges have a proximal end and a distal end, wherein the space between the plurality of raised ridges define a plurality of openings, wherein the proximal end of the tip is attached to the distal second end of the tube.

14. The aspirator tip of claim 13, wherein the tip further comprises a central connection piece, wherein the central connection piece attaches to the plurality of raised ridges and the distal second end of the tube.

15. The aspirator tip of claim 13, wherein the tube is a flexible hollow tube having a wire within the internal housing, wherein the wire allows the tube to retain a position after being bent into the position.
